(19) United States
(12) Patent Application Publication
(10) Pub. No.: US 2017/0193596 A1
(43) Pub. Date: Jul. 6, 2017

(54) System and Method for Providing a Financial Product Using a Customer Product Criteria

(71) Applicants: Cornelis W.J. Bol, Richmond, VA (US); Soumik Chatterjee, Glen Allen, VA (US); Rajsaday Dutt, Glen Allen, VA (US); Abhijit Joshi, Glen Allen, VA (US); Yousef Master, Arlington, VA (US)

(72) Inventors: Cornelis W.J. Bol, Richmond, VA (US); Soumik Chatterjee, Glen Allen, VA (US); Rajsaday Dutt, Glen Allen, VA (US); Abhijit Joshi, Glen Allen, VA (US); Yousef Master, Arlington, VA (US)

(73) Assignee: Capital One Financial Corporation, McLean, VA (US)

(21) Appl. No.: 12/099,249

(22) Filed: Apr. 8, 2008

(51) Int. Cl. G06Q 40/00

(52) U.S. Cl. CPC G06Q 40/025

(57) ABSTRACT

A system and method for providing a financial product using customer product criteria are provided. The method provides for providing a financial product to a customer. The method includes receiving a customer profile associated with a customer. The customer profile has customer preferences and customer personal information. The method also includes obtaining customer credit information using the customer personal information. The method further includes generating customer product criteria using the customer profile. The method additionally includes providing the customer credit information and the customer profile to one or more financial institutions. The method also includes receiving one or more financial products from the one or more financial institutions. The method further includes matching the customer with one or more financial products by comparing the one or more financial products to the customer product criteria.

### FIELD OF THE INVENTION

The present invention relates to a system and method for providing a financial product using customer product criteria.

### BACKGROUND OF THE INVENTION

Significant changes have occurred in how an individual can obtain financial products, such as credit card, debit cards, loans, and the like. Traditionally, a customer would search for a financial product they are interested in and after locating such a financial product the customer would apply for the product. More conventional methods of locating and applying for financial products include web-based providers such as Lending tree. These conventional methods allow a customer to identify and apply for multiple financial products at one time. However, the conventional forms of obtaining a financial product have disadvantages. Some conventional methods require that the customer apply for the financial product prior to receiving information about the financial product in which they have applied. Additionally, some conventional methods do not consider personal information about the customer prior to providing the customer with a list of financial products. In particular, some conventional methods may only provide a customer with a list of financial products having the lowest price, or APR without considering the customers preferences or desires in a financial product.

Overall, these conventional forms of providing financial products fail to provide an effective and efficient way for a customer to obtain a financial product using decision based logic that confirms that the financial product meets the customer preferences or desires.

These and other drawbacks exist with current systems.

### SUMMARY OF THE INVENTION

Various exemplary embodiments provide for systems and methods for providing a financial product using customer product criteria. A system for providing a financial product to a customer includes an aggregator. The aggregator includes a processor, a memory, a communication module, a criteria generation module, and a criteria analyzing module. The processor may run an executable application. The executable application may receive a customer profile associated with a customer. The customer profile may include customer preferences and customer personal information. The memory may store the customer profile. The memory may be in communication with the processor. The communication module may obtain customer credit information using the customer personal information. The communication module may also provide the customer credit information and the customer profile to one or more financial institutions. The communications module may also obtain other customer related information from the one or more financial institutions, a credit bureau, data aggregators, online publishers, corporate entities, charities, and the like. The communication module may additionally receive one or more financial products from the one or more financial institutions. The criteria generation module may generate customer product criteria using the customer profile. The criteria generation module may also use the other customer related information to generate the customer product criteria. The customer product criteria may be adapted to determine whether one or more financial products are suitable for the customer. The criteria analyzing module may match the customer with the one or more financial products by comparing the one or more financial products to the customer product criteria.

Various exemplary embodiments also provide for a method for providing a financial product using customer product criteria. The method includes receiving a customer profile associated with a customer. The customer profile may have customer preferences and customer personal information. The method also includes obtaining customer credit information using the customer personal information. The method further includes generating customer product criteria using the customer profile. The customer product criteria may determine whether one or more financial products are suitable for the customer. The method additionally includes providing the customer credit information and the customer profile to one or more financial institutions. The method also includes receiving one or more financial products from the one or more financial institutions. The method further includes matching the customer with the one or more financial products by comparing the one or more financial products to the customer product criteria.

Other embodiments may also be considered.

### BRIEF DESCRIPTION OF THE DRAWINGS

The embodiments of the present disclosure, together with further objects and advantages, may best be understood by reference to the following description taken in conjunction with the accompanying drawings, in the several Figures of which like reference numerals identify like elements, and in which:

FIG. 1 depicts an exemplary user interface according to various embodiments of the disclosure;

FIG. 2 depicts an exemplary environment for providing a financial product using customer product criteria according to at least one embodiment of the disclosure;

FIG. 3 depicts an exemplary aggregator according to various embodiments of the disclosure;

FIG. 4 depicts an exemplary criteria analyzing module according to various embodiments of the disclosure; and

FIG. 5 depicts an exemplary flow chart which illustrates an exemplary method for providing a financial product using customer product criteria according to various embodiments of the disclosure.

### DETAILED DESCRIPTION OF EXEMPLARY EMBODIMENT(S)

The following description is intended to convey a thorough understanding of the embodiments described by providing a number of specific embodiments and details involving systems and methods for providing a financial product using customer product criteria. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs.

Various exemplary embodiments allow for providing a financial product using customer product criteria.

Exemplary embodiments of systems and methods of the present disclosure provide an improvement over more conventional forms of providing a customer with a financial product, which includes web-based financial product providers such as Lending Tree, lowermybills.com and the like. The systems and methods of the present disclosure provide a financial product using customer product criteria. This offers an effective way for a customer to obtain a financial product that is closely matched to the customers personal criteria or desires.

The systems and methods of the present disclosure present the customer with a financial product that may be tailored to the customers needs by comparing product criteria generated using the customers' profile to one or more financial products provided by one or more financial institutions. As used herein, a financial institution may be any organization that deals with the management of money. A financial institution may be a bank, an insurance company, a credit card company, an individual, and the like. As used herein, a financial product may refer to any product or service offered by a financial institution, such as a loan, a credit card, an insurance policy, a mortgage, a checking account, a debit card, a prepaid card, and the like. As used herein, a customer may be an individual, a group of individuals, a business, or an organization that may be interested in one or more financial products of one or more financial institutions.

Exemplary embodiments of the present disclosure may provide for a web-based environment where the customer may provide a customer profile. The customer may define the customer profile using a user interface akin to, for example a Lending Tree, Priceline, or lowermybills.com user interface. The customer profile, as described below, may include personal information about the customer and the customers preferences for a financial product. The customer preferences may also include information about the customers financial needs, a customer survey of opinions, and customer preferences on other topics. For example, the customer may enter into the user interface personal information such as their name and home address. The customer may also enter that they are interested in receiving offers for credit cards with no enrollment fee and a 3% APR. The customer may also enter that they desire to have the lowest monthly payment, and that their financial cash flow is limited. The customer may also enter that they like sports cars, watching movies, and playing golf. The customer may also enter that they frequently travel for business. In some embodiments, the customer profile may include the customers' responses to calibration questions that may be answered by the customer. It should be appreciated that the customer may define the customer profile using a user interface that is not limited to an Internet-based user interface. Additionally, the customer may define the customer profile using any device or medium used for communication. In some embodiments, the user interface may be provided or generated by an intermediary system such as an aggregator.

Exemplary embodiments of the present disclosure may allow for credit information about the customer to be obtained from a credit bureau or other source. The customer personal information in the customer profile may be used to obtain the customer credit information. Also, the customer personal information may be provided to the credit bureau or other source for credit analysis. The credit bureau may use the customer personal information to obtain the customer credit information. The customer credit information may include the customers' credit rating, credit history, and the like. As used herein, a credit bureau may be a company that compiles credit histories on prospective borrowers and provides credit reports. Some major credit bureaus include Equifax®, Experian®, and TransUnion®. In some embodiments, the customer credit information may be used to confirm and/or verify the customer personal information contained in the customer profile. In another embodiment, to obtain the customer credit information the customer may opt in to a search of their personal information and their credit information. This may prevent the customer from receiving negative marks against their credit history.

Exemplary embodiments of the present disclosure may also allow for other customer related information to be obtained from the one or more financial institutions, the credit bureau, data aggregators, online publishers, corporate entities, charities, and the like. The other customer related information may include customer information such as spending behavior, online browsing behavior (i.e. site frequently visited), purchasing behavior, demographic data, interests, hobbies and the like. The purchase and spending data may include categories such as frequency of spending or purchase, spending, amount of spending, location of high volume spending, and the like.

Exemplary embodiments of the present disclosure may also allow for the generation of customer product criteria. The customer product criteria may be a set of factors or characteristics that can be used to weigh the suitability of one or more financial products for the customer. The customer product criteria may be generated using the customer profile and/or the customer credit information. In some embodiments, the customer credit score may also be used to generate the customer product criteria. For example, an aggregator may receive, inter alia, a customer profile from a customer indicating that the customer prefers a credit card product with a $50 enrollment fee and a 2% APR. The aggregator may also receive a notification from a credit bureau that the customers' credit score is 720. The aggregator may generate customer product criteria using the customer profile and customer credit score. The aggregator may logically decide that the APR is the most important factor when considering a financial product for the customer, while maintaining a $50 enrollment fee is not quite as important. In another embodiment, the customers' responses to calibration questions may also be used to generate the customer product criteria. In another embodiment, the other customer related information may be used to generate the customer product criteria.

Exemplary embodiments of the present disclosure may also allow for financial institutions to receive the customer profile and the customer credit information. The financial institution may also receive the other customer related information. The financial institutions may review the customer profile and the customer credit information to determine whether they are interested in offering one or more financial products to the customer. The financial institution may also review the other customer related information to determine whether they are interested in offering one or more financial products to the customer. Additionally, the financial institution may also determine whether the customer is qualified for one or more financial products. For example, a bank may receive a customer profile that states that the customer prefers a credit card product having 0% APR for the first year. The bank may also receive an indication that the customers credit score is 750. The bank may use the customer preferences and the credit score to determine whether the customer qualifies for one or more financial products and whether the bank offers one or more financial products having 0% APR. If the customer qualifies and the bank has a product meeting the customers preferences, the bank may provide the one or more financial products to an aggregator. In some embodiments, the one or more financial institutions may be provided general guidance as to the customer profile and the credit information required to qualify the customer for the one or more financial products. The one or more financial institutions may submit the financial product offer to the aggregator based on the information received. In another embodiment, the financial institution may upload their entire suite of financial products on the aggregators systems and provide the aggregator with evaluation criteria. In another embodiment, the financial institution may provide a monetary bid with the one or more financial products.

Exemplary embodiments of the present disclosure may also allow for matching the customer with one or more financial products by comparing the customer product criteria with the one or more financial products provided from the one or more financial institutions. For example, the customer product criteria may determine that having an APR or 5% and free balance transfers is important to the customer; thus, an ideal product for the customer may have a 5% APR and free balance transfers. Three financial products from different financial institutions may be received. The first product may have an APR of 10% and free balance transfers, the second product may have an APR of 2% and free balance transfers, and the third product may have an APR of 15% and free balance transfers. Using the product criteria, an aggregator may match the customer with the second offer by determining that the second offer is the best financial product for the customer. The best financial product may be presented to the customer. It should be understood that in some embodiments, the customer may be automatically enrolled in a matched financial product, if the customer consents to such an action. In some embodiments, the customer may be matched with one or more financial products based on a numerical score or rank for the products that are best suited for the customer or comply most closely with the customer product criteria. In this embodiment, the financial products most closely resembling the customer product criteria may have the highest score or best rank. This score may be based on a weighted average of scores determined by the terms of the one or more financial products and the customer product criteria. In some embodiments, the best product may be selected using a heuristic or decision tree model. Further, in this embodiment, the terms of the one or more financial products and the customer product criteria may be used to segment and group products into sub-segments. The customer may be offered the one or more financial products in the sub-segments. In another embodiment, the customer may be presented with one or more financial products that closely comply with the customer product criteria.

In another embodiment, a monetary bid from the one or more financial institutions may be provided with the one or more financial products. The monetary bid may be consider when determining whether one or more financial products match the customer product criteria. In this embodiment, there may be an indication that an auction may be conducted to provide one or more financial products to a customer. Further, in this embodiment, the monetary bid may be considering before, after or simultaneously with the customer product criteria.

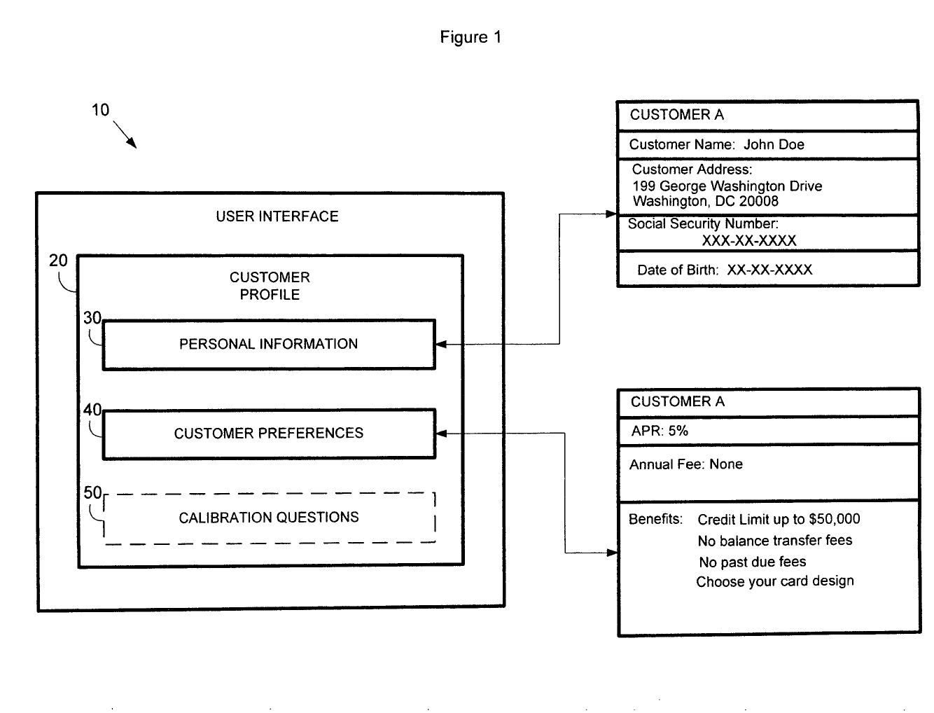

Referring now to the Figures, FIG. 1 depicts an exemplary user interface 10 according to various embodiments of the disclosure. As described above, the user interface 10 may be akin to a conventional user interface of a financial provider such as Lending tree or lowermybills.com. Also, as described above, the customer may use the user interface 10 to provide a customer profile 20 that includes customer personal information 30 and customer preferences 40. The customer profile 20 may also include the customers' response to the calibration questions 50. The customer may also provide any other information that may be relevant in selecting a financial product or obtain credit information.

The customer may enter a website and be prompted to enter customer personal information 30. The customer personal information 30 may include the customers name, address, social security number, date of birth, and any other personal information that may be relevant. The customer may also be prompted to enter customer preferences 40. The customer preferences 40 may include the customers' preferences for a financial product such as the APR, annual fee, product benefits, and the like. The customer preferences 40 may also include information about the customers financial needs, a customer survey of opinions, and customer preferences on other topics. The customer preferences 40 may also include information unrelated to a financial product, such as hobbies, interests, favorite color, etc.

In some embodiments, the customer may be prompted to answer a series of calibration questions 50. The customers' response to the calibration questions 50 may provide a better perspective of the customers interests in a financial product and the customer preferences 40. The questions 50 may be directed to anything that may provide a better understanding of the customers' desire for a financial product. For example, some of the questions 50 may include: how often to you use your credit card?, and which is more important to you: having a low APR or having no annual fee? The questions 50 may also be unrelated to financial products. The questions 50 may also be related to customer spending and purchase behavior, demographic data, and the like.

The customer may provide the customer profile 20 using a personal computer, a mobile device or any other device that may be used to enter information. The customer may also provide the customer profile 20 using an executable application, such as a software executable application, a customized application, a non-customized application, a voice recognition unit, and the like. The customer profile 20 may be provided by an agent on behalf of the customer.

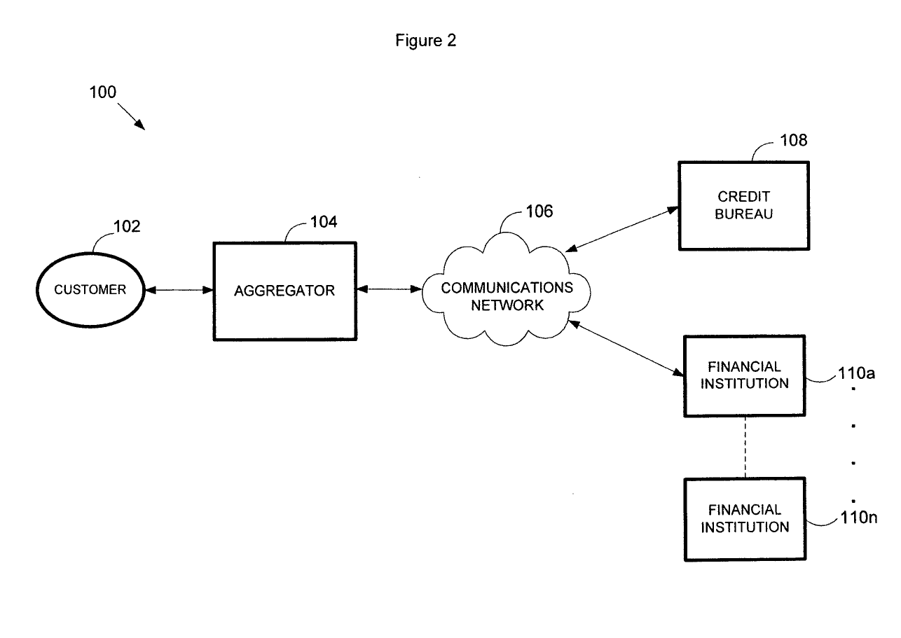

FIG. 2 depicts an exemplary embodiment of a system 100 for providing a financial product using customer product criteria. The exemplary system 100 includes a customer 102, an aggregator 104, a communications network 106, a credit bureau 108, and one or more financial institutions 110a-110n. The aggregator 104 may communicate with the credit bureau 108 and the one or more financial institutions 110a-110n over the communications network 106, and match the customer 102 with a financial product.

The customer 102, as described above, may provide the aggregator 104 with a customer profile 20 that may include customer personal information 30 and customer preferences 40. The aggregator 104 may be an Internet or Web-based hosting system, a Back-end decision logic system, a server, a computer executable application, a computer hardware or software enabled device. The aggregator 104 may be implemented using hardware, software firmware, manual processing, or any combination thereof. A software implementation represents program code that performs specific tasks when executed on a computing-based processor. In particular, the aggregator 104 may be implemented as computer executable instructions. In various embodiments, the aggregator 104 may be hardware attached to or a software application that may be run on the communications network 106. The aggregator 104 may also be hardware attached to or a software application that may be run on the communications network 106.

The aggregator 104 may be an intermediary device capable of interacting with the customer 102, the credit bureau 108, and one or more financial institutions 110a-110n. The aggregator 104 may be coupled to the communications network 106 to communicate with the credit bureau 108. The aggregator 104 may provide the customer profile 20 or customer personal information 30 to the credit bureau 108. The aggregator 104 may receive customer credit information from the credit bureau 108. The aggregator 104 may also be coupled to the communications network 106 to communicate with the one or more financial institutions 110a-110n. The aggregator 104 may provide the customer profile 20 and the customer credit information to the one or more financial institutions 110a-110n. The aggregator 104 may receive the one or more financial products from the one or more financial institutions 110a-110n. The aggregator 104 may also receive a bid, such as a monetary bid, from the one or more financial institutions 110a-110n with the one or more financial products. In some embodiments, the aggregator 104 may include the credit bureau 108, and the one or more financial institutions 110a-110n. Also, in some embodiments, the aggregator 104 may store the customer profile 20, the customer credit information, the customer product criteria, and/or the one or more financial products.

The aggregator 104 may be capable of generating customer product criteria using the customer profile 20 received from the customer 102. The aggregator 104 may also generate the customer product criteria using other customer related information from the one or more financial institutions 110a-110n, the credit bureau 108, data aggregators, online publishers, corporate entities, charities, and/or other sources. The aggregator 104 may also generate the customer product criteria using customer credit information received from the credit bureau 108. The aggregator 104 may also generate the customer product criteria using responses to calibration questions 50 received from the customer 102. The aggregator 104 may use algorithms and/or decision based logic to generate the customer product criteria. The aggregator 104 may use the customer profile 20, the customer credit information, the customers' response to the calibration questions 50, and the other customer related information to assign a certain weight to a particular feature or aspect of one or more financial products.

The aggregator 104 may also be capable of comparing the customer product criteria to one or more financial products received from the one or more financial institutions 110a-110n. The aggregator 104 may use algorithms and/or decision based logical to compare the customer product criteria to the one or more financial products. The aggregator 104 may weigh, score and/or rank the one or more financial products by analyzing the one or more financial products against the customer product criteria.

The aggregator 104 may also conduct an auction to determine or assist in determining the one or more financial products that may be provided to the customer 102. The aggregator 104 may request bids from the one or more financial institutions 110a-110n. The aggregator 104 may determine that one or more financial products of the financial institutions providing the highest bid may be presented to the customer 102. In some embodiments, the aggregator 104 may consider the bid of the one or more financial institutions 110a-110n in conjunction with comparing the one or more financial products to the customer product criteria. The aggregator 104 may determine that the financial institution having a high or good bid and having one or more financial products closely resembling the customer product criteria may be presented to the customer 102.

The one or more financial institutions 110a-110n may interact with the aggregator 104 over the communication network 106. The one or more financial institutions 110a-110n may provide the aggregator 104 with the one or more financial products. The credit bureau 108 may interact with the aggregator 104 over the communication network 106. The credit bureau 108 may provide the aggregator 104 with the customer credit information.

The communications network 106 may be any network sufficient to allow communication between the aggregator 104, the credit bureau 108, and the one or more financial institutions 110a-110n. The communications network 106 may facilitate communication between the aggregator 104, the credit bureau 108, and the one or more financial institutions 110a-110n.

In an embodiment, the one or more financial institutions 110a-110n may be housed within the aggregator 104. In this embodiment, the one or more financial institutions 110a-110n may periodically provide the one or more financial products to the aggregator 104, instead of when the customer 102 seeks the one or more financial products. The aggregator 104 may contain a reserve of financial products that may be considered when the customer requests one or more financial products.

The components depicted in FIG. 2 may be coupled via one or more networks. As referred to herein, a network may include, but is not limited to: e.g., a wide area network (WAN), a local area network (LAN), a global network such as the Internet, a telephone network such as a public switch telephone network, a wireless communication network, a cellular network, an intranet, a satellite network, a GPS network, or the like, or any combination thereof. In exemplary embodiments, the network may include one, or any number of the exemplary types of networks mentioned above, operating as a stand alone network or in cooperation with each other. Use of the term network herein is not intended to limit the network to a single network. The components depicted in FIG. 2 may communicate by electronic transmission through the one or more networks mentioned above, by physical delivery, or by any other communication mechanism. Communication between two components depicted in FIG. 2 may also include communication with any other entities between the two components.

Exemplary system 100 for providing a financial product using product criteria may include one or more network-enabled computers to process interaction between the customer 102, the aggregator 104, the communications network 106, the credit bureau 108, and the one or more financial institutions 110a-110n. As referred to herein, a network-enabled computer may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The one or more network-enabled computers of exemplary system 100 may execute one or more software applications to, for example, receive data as input from an entity accessing the network-enabled computer, process received data, transmit data over a network, and receive data over a network. The one or more network-enabled computers may also include one or more software applications to enable the processing of a card transaction.

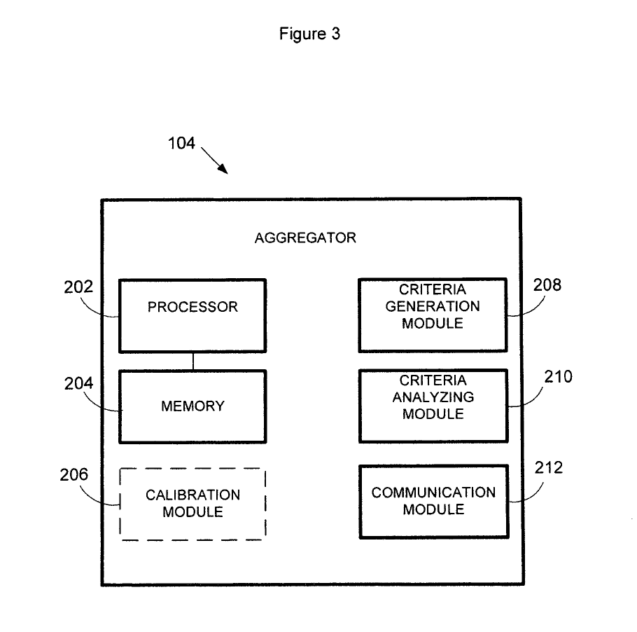

FIG. 3 depicts an exemplary aggregator 104 according to various embodiments of the disclosure. The aggregator 104 may include a processor 202, a memory 204, a calibration module 206, a criteria generation module 208, a criteria analyzing module 210, and a communication module 212.

The processor 202 may run an executable application. The executable application may receive a customer profile 20 associated with a customer 102. The executable application may be in communication with the memory 204, the criteria generation module 208, and the communications module 212. The executable application may provide the customer profile 20 to the memory 204. The executable application may also receive a customers' response to calibration questions 50. The executable application may communicate the responses to the calibration questions 50 to the memory 204, the criteria generation module 208, and the communications module 212. The executable application may also function as the user interface 10. The executable application may be executed on a hardware device, and/or as software. The executable application may initiate and/or communicate a command from the customer 102 to operate the appropriate module. The executable application may communicate with the customer 102 over a network, similar to the communications network 106 discussed above. The executable application may perform some or all of the functions of the aggregator 104.

The processor 202 may be in consistent and/or continuous contact with the aggregator 104. The processor 202 may process data associated with the customer 102, the credit bureau 108, and/or the one or more financial institutions 110a-110n. The processor 202 may execute any of a software module or a executable software program, and cause data to be stored. The operation of the processor 202 may include executing software or coded instructions that may in particular embodiments be associated with the one or more function modules.

The memory 204 may be in communication with the processor 202. The memory 204 may receive the customer profile 20, the customer credit information, and the customers' responses to the calibration questions 50 from the processor 202 and store the customer profile 20, the customer credit information, and the customers' responses to the calibration questions 50. The memory 204 may also receive the other customer related information from the communication module 212 and store the other related customer information. The memory 204 may also store the customer credit information received from the credit bureau 108. The memory 204 may additionally store the customer product criteria generated by the customer generation module 208. The memory 204 may also store one or more matched financial products determined by the customer analyzing module 210. The memory 204 may be in a variety of forms that are able to hold data, instructions, or other information associated with the aggregator 104. The memory 204 may include a database to store data electronically. The memory 204 may be read by the processor 202 or any other aspect of the aggregator 104.

The memory 204 may be coupled to the processor 202 and may include one or more suitable memory devices, such as one or more random access memories (RAMs), read-only memories (ROMs), dynamic random access memories (DRAMs), fast cycle RAMs (FCRAMs), static RAM (SRAMs), field-programmable gate arrays (FPGAs), erasable programmable read-only memories (EPROMs), electrically erasable programmable read-only memories (EEPROMs), microcontrollers, or microprocessors.

The calibration module 206 may generate one or more calibration questions 50 that may be provided to the customer 102. The calibration module 206 may provide the calibration questions 50 to the processor 202. In some embodiments, the calibration module 206 may receive the customers' responses to the calibration questions 50 and provide the customers responses to the criteria generation module 208. In another embodiment, the responses to the calibration questions 50 may be included in the customer profile 20 of the processor 202. The calibration module 206 may receive the calibration questions 50 from the one or more financial institutions 110a-110n, the credit bureau 108 and/or any other sources. In some embodiments, the calibration module 206 may receive the questions 50 from the communications module 212. The calibration module 206 may be optional. Additionally, the functions of the calibration module 206 may be performed by the processor 202.

The criteria generation module 208 may generate customer product criteria using the customer profile 20 received from the processor 202. The criteria generation module 208 may also use the customers' responses to the calibration questions 50 received from the calibration module 206 and/or the processor 202 to generate the customer product criteria. The criteria generation module 208 may also use the other customer related information to generate the customer product criteria. The criteria generation module 208 may provide the customer product criteria to the criteria analyzing module 210. In some embodiments, the criteria generation module 208 and the criteria analyzing module 210 may be the same module. The criteria generation module 208 may use software based instructions, and/or algorithms to generate customer product criteria.

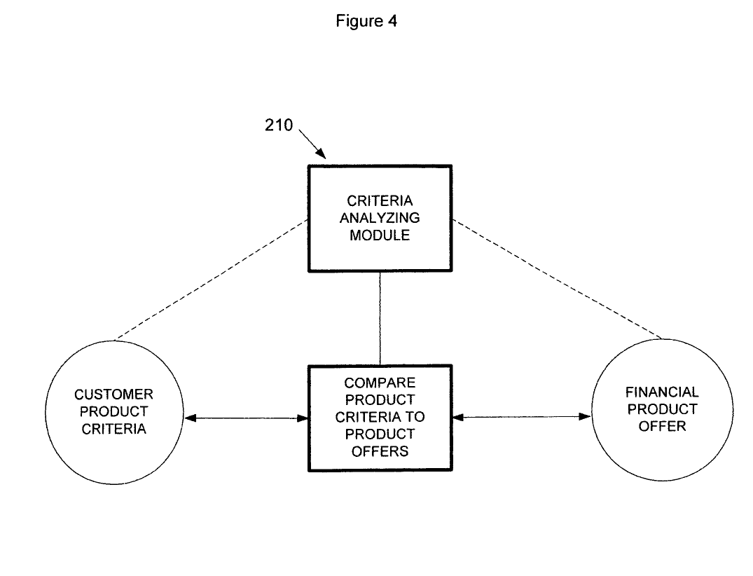

As illustrated in FIG. 4, the criteria analyzing module 210 may be operable to compare the customer product criteria generated by the criteria generation module 208 to the one or more financial products provided by the one or more financial institutions 110a-110n. The criteria analyzing module 210 may determine whether one or more financial products are best suited for the customer 102. The criteria analyzing module 210 may use software based instructions, and/or algorithms to compare the customer product criteria to the one or more financial products. Additionally, the criteria analyzing module 210 may use the software based instructions and/or algorithms to determine the one or more matched financial products. The criteria analyzing module 210 may also conduct the financial product auction, as described above.

The communication module 212 may facilitate communication between the modules, the credit bureau 108 and the one or more financial institutions 110a-110n. The communications module 212 may be in frequent contact with the processor 202, the memory 204, the calibration module 206, the criteria generation module 208, the criteria analyzing module 210, the credit bureau 108, the one or more financial institutions 110a-110n, the customer 102, and/or other sources. The communication module 212 may provide the credit bureau 108 with the customer personal information. The communications module 212 may also receive the customer credit information from the credit bureau 108. The communication module 212 may also provide the one or more financial institutions 110a-110n with the customer profile 20 and customer credit information. The communication module 212 may also receive the one or more financial products from the one or more financial institutions 110a-110n. The communications module 212 may also notify the one or more financial institutions 110a-110n whether the customer 102 accepted or declined the one or more matched financial products. The communications module 212 may also receive other customer related information from the one or more financial institutions 110a-110n, the credit bureau 108, data aggregators, online publishers, corporate entities, charitable entities, and/or any other sources.

The communication module 212 may present the customer 102 with the one or more matched financial products and/or the first matched financial product. The communication module 212 may be capable of initiating or receiving a text message, a telephone call, an email, or any other form of communication. The communication module 212 may be anything capable of receiving and initiating communicating over a communications network.

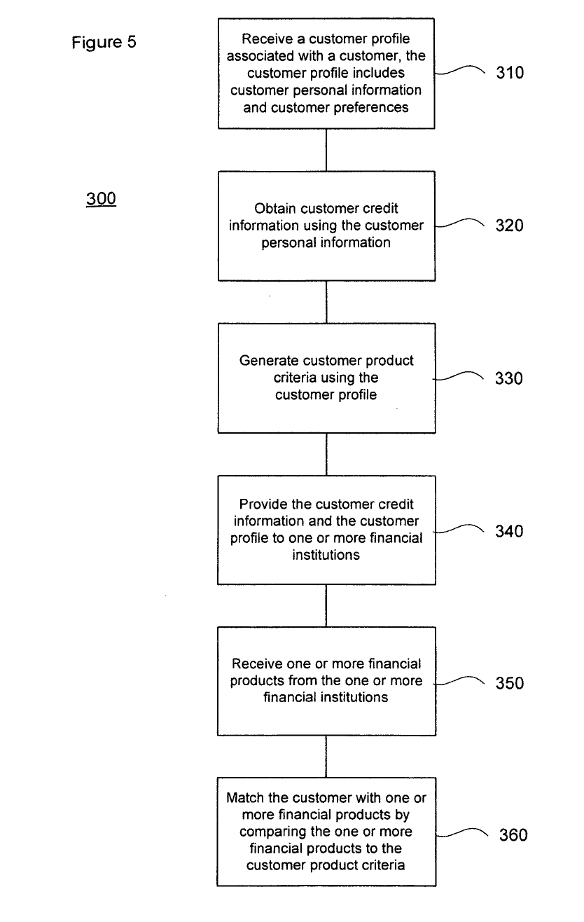

FIG. 5 depicts an exemplary flow chart which illustrates an exemplary method 300 for providing a financial product using customer product criteria according to various embodiments of the disclosure.

At step 310, a customer profile associated with the customer may be received. The customer profile 20 may be received by an aggregator 104. The customer profile 20 may include customer personal information 30 and customer preferences 40. The customer profile 20 may also include customer responses to calibration questions 50. The responses to the calibrated questions 50 may enhance the understanding of the customer preferences 40 at the time of the product criteria generation. As described above, the customer profile 20 may be provided to the aggregator 104 using an executable application or user interface 10. The customer profile 20 may be received through any kind of physical or non-physical channel.

At step 320, the customer credit information may be obtained using the customer personal information. The customer credit information may be obtained by the aggregator 104. The aggregator 104 may obtain the customer credit information from the credit bureau 108. The customer credit information may be used to verify the personal information 30 provided by the customer 102. The customer 102 may opt in to a search of the customer credit information prior to the customer credit information being obtained.

At step 330, the customer product criteria may be generated using the customer profile. The aggregator 104 may generate the customer product criteria. The customer credit information may also be used to generate the customer product criteria. The other customer related information may be used to generate the customer product criteria. The customer product criteria may be used to determine whether one or more financial products are best for the customer 102. The one or more financial products that most closely resemble the customer product criteria may be the best financial product. As described above, an algorithm and/or decision based logic may be used to generate the customer product criteria.

At step 340, the customer credit information and the customer profile may be provided to the one or more financial institutions. The aggregator 104 may provide the customer credit information and the customer profile 20 to the one or more financial institutions 110a-110n. The aggregator 104 may provide the customer credit information and customer profile 20 over the communications network 106. The one or more financial institutions 110a-110n may use the customer credit information and the customer profile 20 to determine whether to provide one or more financial products to the aggregator 104.

At step 350, one or more financial products may be received from the one or more financial institutions 110a-110n. The aggregator 104 may receive the one or more financial products from the one or more financial institutions 110a-110n. The aggregator 104 may receive the one or more financial products over the communication network 106. In some embodiments, the aggregator 104 may receive a monetary bid from the one or more financial institutions 110a-110n in conjunction with the one or more financial products. This may generally occur when the aggregator 104 indicates to the one or more financial institutions 110a-110n that an auction will occur to provide a financial product to a customer 102.

At step 360, the customer may be matched with the one or more financial products by comparing the customer product criteria to the one or more financial products. The aggregator 104 may match the customer 102 with the one or more financial products. The aggregator 104 may match the customer 104 using an algorithm and/or decision based logic. The aggregator 104 may match the customer with a first matched financial product. The aggregator 104 may select the first matched financial product if the product most closely resembles the customer product criteria. Additionally, the aggregator 104 may select the first matched product if the product obtains a higher score or a better rank than the other financial products when compared to the customer product criteria. The aggregator 104 may consider a monetary bid provided by the one or more financial institutions 110a-110n in conjunction with the one or more financial products when matching the customer with the one or more financial products.

The customer 102 may be presented with the one or more matched financial products. The aggregator 104 may present the customer 102 with the one or more matched financial products. The aggregator 104 may also present the customer 102 with the first matched financial product. After presenting the one or more matched financial products, the customer 102 may select one of the matched financial products. The aggregator 104 may notify the one or more financial institutions 110a-110n whether the customer selected their one or more financial products. In some embodiments, the customer 102 may be automatically enrolled in the one or more matched financial products. The customer 102 may receive a notification of their enrollment in the one or more matched financial products.

The embodiments of the present invention are not to be limited in scope by the specific embodiments described herein. Thus, such modifications are intended to fall within the scope of the following appended claims. Further, although some of the embodiments of the present invention have been described herein in the context of a particular implementation in a particular environment for a particular purpose, those of ordinary skill in the art should recognize that its usefulness is not limited thereto and that the embodiments of the present invention can be beneficially implemented in any number of environments for any number of purposes. Accordingly, the claims set forth below should be construed in view of the full breadth and spirit of the embodiments of the present invention as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

1. A method for providing a financial product to a customer, comprising:
receiving, at an aggregation processor via a network, a customer profile associated with a customer, the customer profile comprising customer preferences and customer personal information;
receiving, at the aggregation processor via a network, responses to calibration questions previously provided to the customer, the responses to the calibration questions providing additional information regarding customer preferences;
obtaining, from a credit processor via a network, customer credit information using the customer personal information;
determining, using the aggregation processor a set of factors that can be used to weigh the suitability of financial products for the customer, wherein the factors are generated by an aggregator, in continuous contact with the aggregation processor, using the customer profile and the customer credit information, and at least one of the factors is determined to be more important to the customer than one or more other factors based on the responses to the calibration questions;
providing, using the aggregation processor, the customer credit information and the customer profile to one or more financial institution systems;
receiving, at the aggregation processor via a network, one or more financial products from the one or more financial institution systems;
matching, using the aggregation processors, the customer with the one or more financial products by comparing the one or more financial products to the factors, wherein matching the customer with the one or more financial products comprises determining a numerical score for the one or more financial products by assigning a score to each factor of the one or more financial products based on the responses to the calibration questions, calculating a weighted average of the factors of each financial product, and determining that the one or more financial products receiving a higher numerical score are the most suitable for the customer;
presenting the one or more matched financial products to a user device for display; and
notifying, via the aggregation processor, each of the one or more financial institution systems whether the customer accepted or rejected the financial product received from the respective financial institution system.

2. The method of claim 1, wherein matching the customer further comprises:
selecting a first matched financial product for the customer; and
presenting the first matched financial product to the customer.

3. The method of claim 2, wherein the first matched financial product is selected for most closely comparing with the factors.

4. The method of claim 1, further comprising:
automatically accepting a first financial product on behalf of the customer; and
notifying the customer of their enrollment in the first financial product.

5. (canceled)

6. (canceled)

7. (canceled)

8. The method of claim 1, further comprising:
receiving, at the aggregation processor, an indication from the customer that the customer decided to opt in to a search of their credit information.

9. The method of claim 1, wherein the customer credit information is obtained from a credit bureau system.

10. (canceled)

11. The method of claim 1, wherein matching the customer with the one or more financial products comprises considering a monetary bid provided by the one or more financial institution systems in conjunction with the one or more financial products.

12. (canceled)

13. The method of claim 1, wherein the factors are also generated using other customer related information.

14. A system for providing a financial product to a customer comprising an aggregator, the aggregator comprising:
a first communication processor that runs an executable application, the executable application configured to receive, via a network, a customer profile associated with a customer and receive responses to calibration questions previously provided to the customer, the responses to the calibration questions providing additional information regarding customer preferences, the customer profile comprising customer preferences and customer personal information;
a memory configured to store the customer profile, the memory being in communication with the processor;
a second communication processor that:
obtains customer credit information, via a network, using the customer personal information;
provides the customer credit information and the customer profile to one or more financial institutions; and
receives one or more financial products from the one or more financial institutions;
a determination processor that determines a set of factors that can be used to weigh the suitability of financial products for the customer, wherein the factors are generated by the aggregator using the customer profile and the customer credit information, and at least one of the factors is determined to be more important to the customer than one or more other factors based on the responses to the calibration questions; and
an analyzing processor that matches the customer with one or more financial products by comparing the one or more financial products to the factors, wherein matching the customer with the one or more financial products comprises determining a numerical score for the one or more financial products by assigning a score to each factor of the one or more financial products based on the responses to the calibration questions, calculating a weighted average of the factors of each financial product, and determining that the one or more financial products receiving a higher numerical score are the most suitable for the customer;
wherein the aggregator:
presents the one or more matched financial products to a user device for display; and
notifies each of the one or more financial institution systems whether the customer accepted or rejected the financial product received from the respective financial institution system.

15. The system of claim 14, further comprising:
a calibration processor that generates one or more calibration questions provided to the customer.

16. (canceled)

17. (canceled)

18. The system of claim 14, wherein the analyzing processor selects a first matched financial product for the customer by comparing the factors to the one or more financial products and determining that the first matched financial product most closely compares with the factors.

19. The system of claim 14, wherein the analyzing processor matches the customer with the one or more financial products by considering a monetary bid provided by the one or more financial institutions in conjunction with the one or more financial products.

20. The system of claim 14, wherein the second communication processor further receives other customer related information.

21. A computer implemented method for providing a financial product to a customer, comprising the acts of:
receiving, at an aggregator processor via a network, a customer profile associated with a customer, the customer profile comprising customer preferences and customer personal information;
receiving, at the aggregator processor via a network, responses to calibration questions previously provided to the customer, the responses to the calibration questions providing additional information regarding customer preferences;
determining, using the aggregator processor, a set of factors that can be used to weigh the suitability of financial products for the customer, wherein the factors are generated by an aggregator using the customer profile, and at least one of the factors is determined to be more important to the customer than one or more other factors based on the responses to the calibration questions;
providing, from the aggregator processor via a network, the customer profile to one or more financial institution systems;
receiving, at the aggregator processor, one or more financial products from the one or more financial institution systems;
matching, using the aggregator processor, the customer with a financial product by comparing the one or more financial products to the factors, wherein matching the customer with the one or more financial products comprises determining a numerical for the one or more financial products by assigning a score to each factor of the one or more financial products based on the responses to the calibration questions, calculating a weighted average of the factors of each financial product, and determining that the one or more financial products receiving a higher numerical score are the most suitable for the customer;
presenting the one or more matched financial products to a user device for display; and
notifying, via the aggregation processor, each of the one or more financial institution systems whether the customer accepted or rejected the financial product received from the respective financial institution system.

22. The computer implemented method of claim 21, further comprising:
obtaining customer credit information using the customer personal information; and
providing the customer credit information to the one or more financial institution systems.

23. The system of claim 14, wherein the first communication processor and the second communication processor are the same processor.
